(19) United States
(12) Patent Application Publication
(10) Pub. No.: US 2026/0211967 A1
(43) Pub. Date: Jul. 23, 2026

(54) COMPUTING NON-LINEAR FUNCTIONS USING A NON-UNIFORM ALLOCATION OF LINEAR POLYNOMIAL FUNCTIONS

(71) Applicant: QUALCOMM Incorporated, San Diego, CA (US)

(72) Inventors: Mehdi SADEGHZADEH, Brookline, MA (US); Sundar Rajan BALASUBRAMANIAN, Groton, MA (US); Deepak MATHEW, Acton, MA (US); Srijesh SUDARSANAN, Waltham, MA (US); Yurong SUN, Acton, MA (US)

(21) Appl. No.: 19/028,094

(22) Filed: Jan. 17, 2025

(51) Int. Cl. G06F 17/11

(52) U.S. Cl. CPC G06F 17/11

(57) ABSTRACT

Certain aspects of the present disclosure provide techniques and apparatus for computing non-linear functions. Aspects include dividing a range associated with input data for a non-linear function into a plurality of input segments. Aspects include slicing the plurality of input segments into a plurality of slices, wherein each slice corresponds to a different subset of the plurality of input segments. Aspects include allocating a plurality of polynomial functions to the plurality of slices in a non-uniform manner. Aspects include computing, based on the allocating, the non-linear function using the plurality of polynomial functions.

### TECHNICAL FIELD

Aspects of the present disclosure generally relate to non-linear functions and, more particularly, to techniques for computing non-linear functions using non-uniform slices of linear polynomial functions.

### BACKGROUND

Non-linear functions may be used in activation functions for machine learning models, such as neural networks. To compute a non-linear function, processors (e.g., central processing units (CPUs)) use piecewise linear approximation, which is a technique used to approximate a continuation function (e.g., the non-linear function) using a series of linear segments. For instance, the range of input values for the particular non-linear function may be divided into smaller segments and one or more linear polynomial functions may be fitted to each particular segment of the non-linear function.

### BRIEF SUMMARY

Certain aspects provide a method for computing non-linear functions, comprising: dividing a range associated with input data for a non-linear function into a plurality of input segments; slicing the plurality of input segments into a plurality of slices, wherein each slice corresponds to a different subset of the plurality of input segments; allocating a plurality of polynomial functions to the plurality of slices in a non-uniform manner; and computing, based on the allocating, the non-linear function using the plurality of polynomial functions.

Certain aspects provide a processing system for computing non-learning functions, comprising: at least one memory having executable instructions stored thereon; and one or more processors configured to execute the executable instructions to cause the processing system to perform operations comprising: dividing a range associated with input data for a non-linear function into a plurality of input segments; slicing the plurality of input segments into a plurality of slices, wherein each slice corresponds to a different subset of the plurality of input segments; allocating a plurality of polynomial functions to the plurality of slices in a non-uniform manner; and computing, based on the allocating, the non-linear function using the plurality of polynomial functions.

Certain aspects provide a non-transitory computer-readable medium comprising instructions to be executed in a processor, wherein the instructions when executed in the processor cause the processor to perform operations comprising: dividing a range associated with input data for a non-linear function into a plurality of input segments; slicing the plurality of input segments into a plurality of slices, wherein each slice corresponds to a different subset of the plurality of input segments; allocating a plurality of polynomial functions to the plurality of slices in a non-uniform manner; and computing, based on the allocating, the non-linear function using the plurality of polynomial functions.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts a non-linear function according to various aspects of the present disclosure.

FIG. 2 depicts a graphical representation of an absolute error between a non-linear function and an approximation of the non-linear function using a uniform distribution of linear polynomial functions according to various aspects of the present disclosure.

FIG. 3 depicts a graphical representation of an absolute error between a non-linear function and an approximation of the non-linear function using a non-uniform distribution of linear polynomial function according to various aspects of the present disclosure.

FIG. 4 depicts an example algorithm for computing a non-linear function according to various aspects of the present disclosure.

FIG. 5 depicts a method for computing a non-linear function according to various aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for computing non-linear functions.

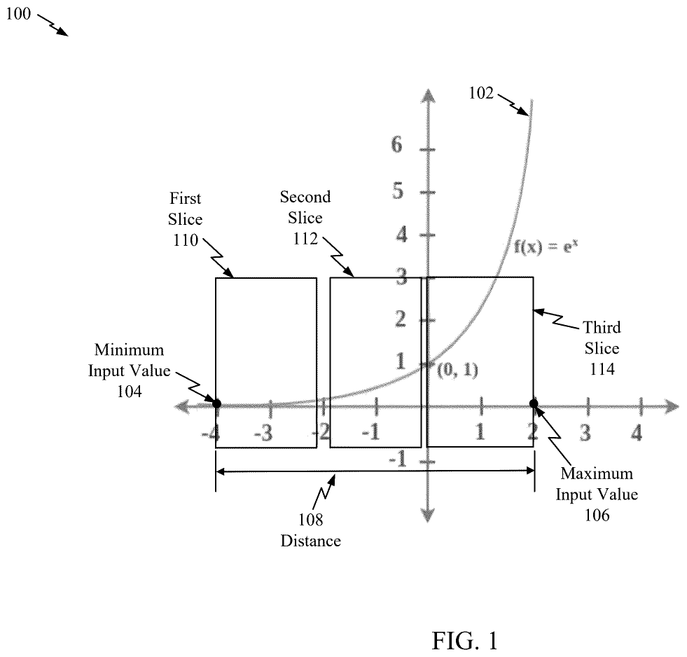

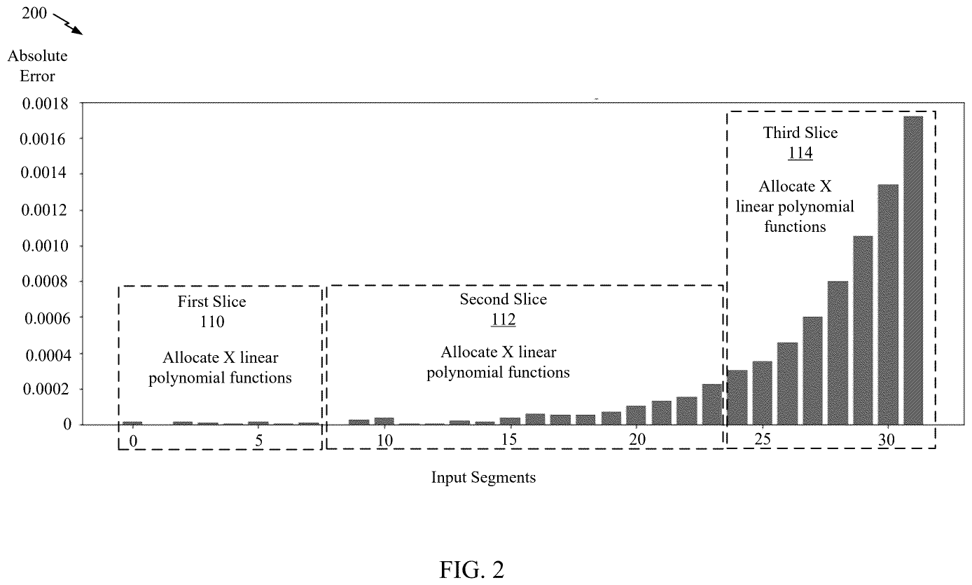

Example aspects of the present disclosure are directed to techniques for computing non-linear functions, such as the non-linear function depicted in FIG. 1. As discussed above, a non-linear function may be computed by allocating (e.g., fitting) a plurality of linear stepwise polynomial functions to the non-linear function. However, conventional techniques that rely on computing non-linear functions using such approximation techniques typically allocate the plurality of linear stepwise polynomial functions in a uniform manner. As will be discussed with reference to FIG. 2, this approach for uniformly allocating the plurality of linear stepwise polynomial functions results in an error between the non-linear function and the approximation of the non-linear function being non-uniformly distributed. For instance, the error may be greater at the edges of the non-linear function. This non-uniform distribution of the error can affect the accuracy of applications (e.g., machine learning models) in which such non-linear functions are used.

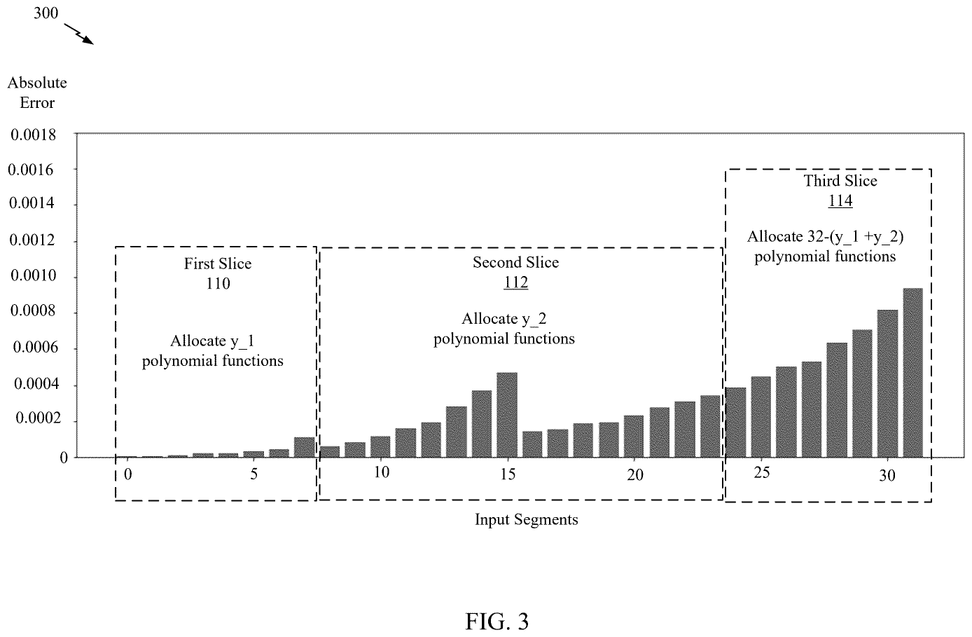

Example aspects of the present disclosure are directed to techniques for computing non-linear functions using approximation techniques involving a plurality of linear stepwise polynomial functions that are distributed in a non-uniform manner. For example, as will be discussed with reference to FIG. 3, a plurality of input segments for the non-linear function may be sliced into a plurality of slices, with at least one of the slices including a different number of input segments compared to every other slice. Furthermore, the plurality of linear stepwise polynomial functions may be allocated amongst the plurality of slices in a non-uniform manner. By allocating the linear stepwise polynomial function in this non-uniform manner, the error between the non-linear function and the resulting approximation of the non-linear function may be reduced resulting in improved operation (e.g., more accurate) of applications (e.g., machine learning models) that use such non-linear functions. In this manner, the functionality of devices (e.g., modems, Internet-of-Things (IoT), wearable devices) implementing such applications may be improved as a result of the improved operation of such applications. For instance, the disclosed techniques improve the efficiency of computing resources executing such applications and, as a result, the battery life of such devices may be improved.

### Example Non-Linear Function

FIG. 1 is a graph 100 of a non-linear function 102 according to various aspects of the present disclosure. For example, the non-linear function 102 may be an exponential function included in an activation function for an activation layer of a machine learning model. Examples of such non-linear functions that may be included in the activation layer of the machine learning model may include, without limitation, a Gaussian error limit unit (GeLu) function or a softmax activation function It should be appreciated, however, that the disclosed techniques for computing non-linear functions may be applicable to any suitable non-linear function. For instance, in some aspects, the non-linear function may be associated with an activation layer of a machine learning model (e.g., a neural network).

In certain aspects, the non-linear function 102 may be represented by the following formula:

$$f ( x ) = {e}^{x} . \qquad ( Equation 1 )$$

In the above formula (i.e., Equation 1), x represents a particular input value for the non-linear function 102 and f(x) represents the output of the non-linear function for the particular input value. Thus, as illustrated in FIG. 1, the non-linear function 102 may be computed for different input values (e.g., denoted along the horizontal axis of graph 100) that are provided as an input value for the non-linear function 102. For example, the input values may range from a minimum input value 104 (e.g., −4) to a maximum input value 106 (e.g., +2).

To approximate the non-linear function 102, conventional approaches may divide a range 108 of the input values for the non-linear function 102 into a plurality of input segments. For example, as illustrated in FIG. 1, the range 108 of the input values for the non-linear function 102 may correspond to a distance (e.g., 6) between the minimum input value 104 for the non-linear function 102 and the maximum input value 106 for the non-linear function 102.

Conventional approaches for approximating the non-linear function 102 may divide the range 108 of the input values for the non-linear function 102 into a fixed number of input segments. For example, conventional approaches may implement the following formula:

$$c = \frac{ma ( x ) - min ( x )}{N} . \qquad ( Equation 2 )$$

In the above-formula (i.e., Equation 2), ma(x) represents the maximum input value 106 of the input values for the non-linear function 102; min(x) represents the minimum input value 104 of the input values for the non-linear function 102; and N represents the fixed number of input segments that the range 108 of the non-linear function 102 is to be divided into in order to compute the non-linear function 102.

Conventional approaches may also include slicing the plurality of input segments into M slices. For example, as illustrated in FIG. 1, the plurality of input segments of the non-linear function 102 may be sliced into three different slices (e.g., M=3), namely a first slice 110, a second slice 112, and a third slice 114. It should be appreciated that, in other aspects, the plurality of input segments of the non-linear function 102 may be sliced into more slices (e.g., M>3).

In some aspects, a total number of input segments included in each of the different slices (e.g., first slice 110, second slice 112, third slice 114) may differ. For example, the first slice 110, which may correspond to an edge portion of the non-linear function 102, may include a first number (e.g., 8) of input segments. The second slice 112, which may correspond to a middle portion of the non-linear function 102, may include a second number (e.g., 16) of input segments that is different (e.g., greater) than the first number. The third slice 114, which may correspond to another edge portion of the non-linear function 102, may include a third number (e.g., 8) of input segments. In some aspects, the total number of input segments included in the first slice 110 and the third slice 114 may be the same and may be different (e.g., less than) the total number of input segments included in the second slice 112.

Conventional approaches for approximating the non-linear function 102 may include allocating a plurality of linear polynomial functions to the different slices of the non-linear function 102 in a uniform manner. The linear polynomial functions may be represented by the following formula:

$$fapprox , i = {a}_{i} * {x}_{i} + {b}_{i} . \qquad ( Equation 3 )$$

In the above formula (i.e., Equation 3), aᵢ represents the slope of the linear polynomial function in the i-th range; xᵢ represents an input value for the non-linear function 102 in the i-th range; and bᵢ represents the intercept point of the linear polynomial function in the i-th range.

In some aspects, the specific input values for the non-linear function 102 that are used as inputs for the linear polynomial functions may be determined using the following formula:

$$( i - 1 ) * c < {x}_{1} < i * c . \qquad ( Equation 4 )$$

In the above formula (e.g., Equation 4), i represents a counter (e.g., initialized to have a value of 0) that gets incremented for each successive linear polynomial function that is used to compute (e.g., approximate) the non-linear function 102; c represents the range 108 of the input values for the non-linear function 102; and xᵢ represents an input value for the non-linear function 102 in the i-th range

In some aspects, a portion of a particular input value (e.g., xᵢ) may be used as a lookup table to obtain one or more input parameters (e.g., aᵢ and bᵢ) for the linear polynomial function (e.g., fapprox, i). For instance, in some aspects, the portion of the particular input value may include one or more bits of the particular input value. For example, the portion of the particular input value may include a threshold number (e.g., 5) of the most-significant bits of the particular input value.

Conventional approaches for piecewise linear approximation of the non-linear function 102 allocate (e.g., fit) the same number of linear polynomial functions to each of the plurality of slices (e.g., first slice 110, the second slice 112, and the third slice 114) of the plurality of input segments (e.g., computed using Equation 2 discussed above) for the non-linear function 102. Allocating the linear polynomial functions in such a uniform manner causes the residual error to be distributed non-uniformly. For instance, as will be discussed with reference to FIG. 2, the residual error between the non-linear function 102 and the computed approximation of the non-linear function 102 may be higher at certain portions (e.g., edges) of the non-linear function 102.

### Graphical Representation of Error Between a Non-Linear Function and an Approximation of the Non-Linear Function Using Uniformly Allocating Linear Polynomial Functions

FIG. 2 is a graph 200 depicting an absolute error at each of the plurality of input segments (e.g., 32) of the non-linear function 102 of FIG. 1. As illustrated, the absolute error is distributed in a non-linear manner, with the peak error occurring at a last input segment (e.g., input segment 31) included in the third slice 114 of the plurality of slices of the non-linear function 102. This non-linear distribution of the absolute error is due, at least in part, to the uniform allocation (e.g., allocating the same number of linear polynomial functions to each slice of the input segments) of the linear polynomial functions amongst the different slices of the inputs segments according to conventional approaches for piecewise linear approximation of the non-linear function 102. As will be discussed below in more detail with reference to FIG. 3, the disclosed techniques are directed to computing non-linear functions, such as the non-linear function 102 discussed above with reference to FIG. 1, by allocating the linear polynomial functions in a non-uniform manner amongst the different slices of the input segments.

### Graphical Representation of Residual Error Between a Non-Linear Function and an Approximation of the Non-Linear Function Using Non-Uniformly Allocating Linear Polynomial Functions

FIG. 3 is a graph 300 depicting an absolute error at each of the plurality of input segments (e.g., 32) of the non-linear function 102 of FIG. 1. As illustrated, the absolute error between a last input segment (e.g., input segment 31) of the non-linear function 102 and a corresponding last input segment of the approximated non-linear function is reduced (e.g., cut in half) compared to the absolute error for the same input segment in the graph 200 depicted in FIG. 2. This is due, at least in part, to the linear polynomial functions being allocated in a non-uniform manner amongst the different slices (e.g., the first slice 110, the second slice 112, and the third slice 114).

In certain aspects, a first number (e.g., y_1) of linear polynomial functions are allocated to the first slice 110, a second number (e.g., y_2) of linear polynomial functions are allocated to the second slice 112, and a third number (e.g., 32−(y_1+_y_2)) of linear polynomial functions are allocated to the third slice 114. Furthermore, since the second slice 112 of the input segments corresponds to a portion of the non-linear function 102 having a greater slope than a portion of the non-linear function 102 to which the first slice 110 corresponds, the total number (e.g., y_2) of linear polynomial functions allocated to the second slice 112 of the input segments may be greater than the total number (e.g., y_1) of linear polynomial functions allocated to the first slice 110 of the input segments.

In some aspects, the total number of linear polynomial functions allocated to the third slice 114 of the input segments may be a function of the total number of input segments (e.g., N in Equation 2 above), the total number (e.g. y_1) of linear polynomial functions allocated to the first slice 110, and the total number (e.g., y_2) of linear polynomial functions allocated to the third slice 112. For instance, the total number of linear polynomial functions allocated to the third slice 114 of the input segments may be determined using the following formula:

$$N - ( y\_ 1 + y\_ 2 ) . \qquad ( Equation 5 )$$

By allocating the linear polynomial functions non-uniformly amongst the different slices of the input segments, the disclosed techniques may, as discussed above, reduce the absolute error between the non-linear function 102 and the approximation of the non-linear function 102 using the disclosed techniques (e.g., non-uniform distribution of linear polynomial functions). For instance, as may be seen in FIG. 3, the absolute error at edges (e.g., input segment 31 in FIG. 3) using the disclosed techniques may be lower compared to the absolute error at edges (e.g., input segment 31 in FIG. 2) using conventional approaches. Furthermore, by reducing the absolute error, the disclosed techniques, which may be implemented in devices (e.g., modems, wearable devices, internet-of-things (IoT) devices), may provide improved accuracy of a machine learning model running on such devices. The improved accuracy of the machine learning model running on such devices may improve the function of such devices because computing resources included on such devices and used to execute the machine learning model may be more efficient thereby improving numerous features of such devices. As an example, such devices may be battery-operated and the life of batteries used on such devices may be extended due, at least in part, to the improve efficiency of computing resources that are utilized to execute the improved (e.g., more accurate) machine learning model.

Although FIG. 3 was discussed with reference to allocating more linear polynomial functions to the second slice 112 of the input segments than to the first slice 110 of the input segments and to the third slice 114 of the input segments, it should be appreciated that the scope of the present disclosure is intended to cover any suitable distribution of the linear polynomial functions amongst the different slices of the input segments so long as the distribution between at least two of the different slices is non-uniform. For example, in some aspects, the total number (e.g., y_1) of linear polynomial functions allocated to the first slice 110 may be greater than the total number (e.g., y_2) of linear polynomial functions allocated to the second slice 112 and the total number (e.g., 32−(y_1+y_2)) allocated to the third slice 114. Alternatively, in some aspects, the total number of linear polynomial functions allocated to the third slice 114 may be greater than the total number of linear polynomial functions allocated to the first slice 110 and the second slice 112.

Furthermore, although FIG. 3 is discussed with reference to slicing the plurality of input segments into 3 slices, it should be appreciated that the scope of the present disclosure is intended to cover slicing the plurality of input segments into any suitable number of slices. For example, in some aspects, the plurality of input segments may be sliced into 5 or more separate slices.

### Example Algorithm for Computing a Non-Linear Function Using Non-Uniformly Distributed Linear Polynomial Functions

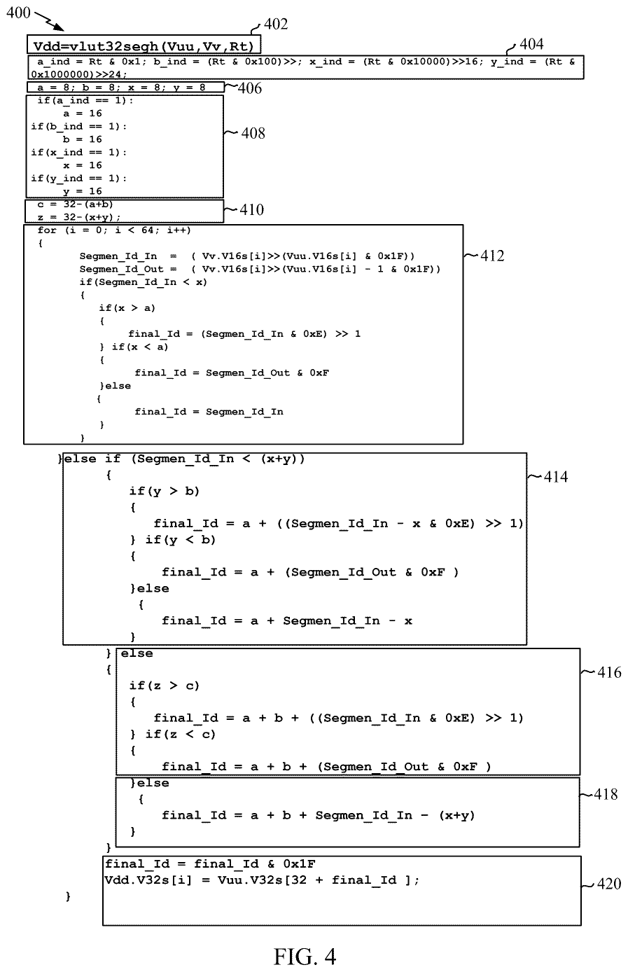

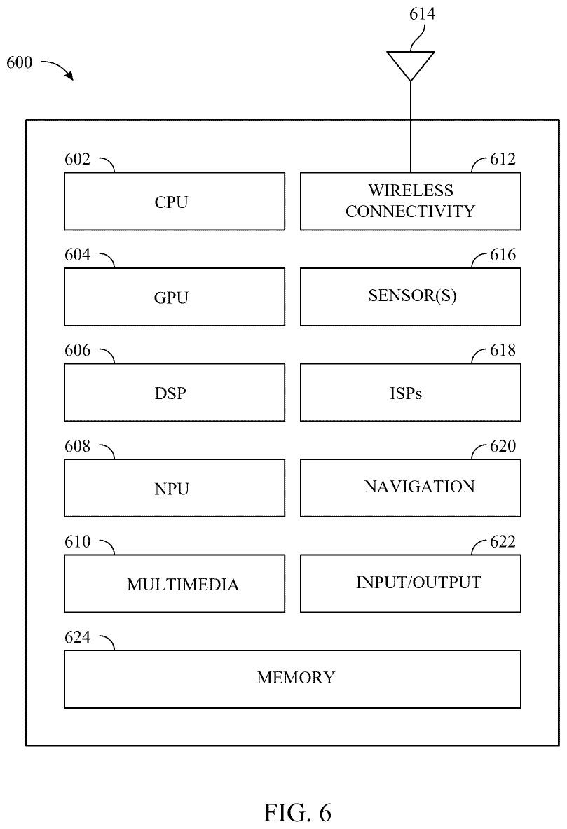

FIG. 4 depicts an algorithm 400 for computing non-linear functions using non-uniformly distributed linear polynomial functions according to some aspects of the present disclosure. For example, the algorithm 400 is depicted as computer-executable instructions that may be executed by a processing system, such as the processing system 600 discussed below with reference to FIG. 6.

As will be discussed below in more detail, the algorithm 400 may include different loops (e.g., for, else if, else) that define which input/output segment is currently being evaluated. For instance, there may be three input segments, and the algorithm 400 may be used to find the input segment. Then, the algorithm 400 may determine whether to decimate, interpolate, or 1:1 map the output for the respective input segment.

In some aspects, the algorithm 400 may be implemented as a function 402 (e.g., labeled Vdd). The function 402 may include multiple input variables, Vuu, Vvv, and Rt. For instance, input variable Vuu may correspond to the lookup table for a particular input value. Input variable Vv may correspond to the particular input value and input variable Rt may indicate how many slices of the plurality of input segments (e.g., 32 total) for the non-linear function (e.g., non-linear function 102 of FIG. 1) should be generated. In some aspects, the input variable Rt may be user-specified for a given application.

The function 402 may include, at 404, a definition for four different local variables (e.g., a_ind; b_ind; x_ind; and y_ind). For instance, in some aspects, the definition for each of the four different local variables may include a bitwise AND operation for determining a logic value (e.g., 0 or 1) for the respective local variable.

For example, the definition for the first local variable, a_ind, may include a bitwise AND operation in which a least significant bit of the input variable, Rt, is compared to 0x1 (e.g., represented as 0000000000000001 in binary). If both bits are 1, the logic value of a_ind is 1. Otherwise, the logic value of a_ind is 0.

The definition for the second local variable, b_ind, may include a bitwise AND operation in which the 9^{th} bit of input variable, Rt, is compared to 0x100 (e.g., represented as 000000010000000 in binary). If both bits are 1, the logic value of b_ind is 1. Otherwise, the logic value of b_ind is 0.

The definition for the third local variable, x_ind, may include a bitwise AND operation in which the 17^{th} bit of input variable, Rt, is compared to 0x10000. If both bits are 1, the logic value of x_ind is 1. Otherwise, the logic value of x_ind is 0.

The definition for the fourth local variable, y_ind, may include a bitwise AND operation in which the 25 bit of input variable, Rt, is compared to 0x1000000. If both bits are 1, then logic value of y_ind is 1. Otherwise, the logic value of y_ind is 0.

In some aspects, the function 402 may, at 406, initial values for variables (e.g., a, b, x, and y) may be assigned. For example, as illustrated in FIG. 4, each of variables a, b, x, and y may be assigned an initial value of 8.

In some aspects, the function 402 may, at 408 include a logic check (e.g., implemented as an if statement) for each of the local variables (e.g., a_ind, b_ind, x_ind, and y_ind) defined above at 404. For example, if the logic value of the first local variable, a_ind, is 1, then variable “a” may be reassigned a value of 16. If the logic value of the second local variable, b_ind is 1, then variable “b” may be reassigned a value of 16. If the logic value of the third local variable, x_ind, is 1, then variable “x” may be reassigned a value of 16. If the logic value of the third variable x_ind is 1, then variable “x” may be reassigned a value of 16. If the logic value of the fourth local variable, y_ind, is 1, then variable “y” may be reassigned a value of 16.

In some aspects, the function 402 may define variable “c” and variable “z” as shown. For instance, variable “c” may be defined as the resultant of the number of input segments (e.g., 32) minus the sum of variables “a” and “b” discussed above. Furthermore, variable “z” may be defined as the resultant of the number of input segments minus the sum of variables “x” and “y” discussed above.

In some aspects, the function 402 may increment through each of a plurality of inputs values for the non-linear function. As illustrated, the function 402 may include a for loop 412 having a for loop counter, i, that may be assigned an initial value of zero and may be incremented after each iteration of the for loop 412. Within the for loop 412, a definition is included for variable “Segmen_Id_In” as shown.

In some aspects, the definition for “Segmen_Id_In includes a bitwise operation that is used to perform a variable-length right-shift on a specific element of a vector (e.g., Vv.v16s[i]). The vector Vv.16s[i] represents the i-th element of the 16-bit signed integer vector. In addition, Vuu.16s[i] & 0x1F represents a bitwise AND operation between the i-th element of the 16-bit signed integer vector Vuu.v16s and the hexadecimal value 0x1F. The purpose of this particular bitwise AND operation is to extract the least significant 5 bits of the i-th element of Vuu.v16s. This is because the 0x1F mask will only keep the last 5 bits of the value, effectively discarding the upper bits.

The operation Vv.v16s[i]>>(Vuu.v16s[i] & 0x1F) performs a right-shift operation on the i-th element of Vv.v16s. The number of positions to shift is determined by the value of the bitwise AND operation (e.g., Vuu.v16s[i] & 0x1F), which means that the shift amount is variable and can be different for each element in the vector.

Also within the for loop 412, a definition is included for variable, “Segmen_Id_Out” as shown. The definition generally results in a variable-length right shift on the i-th element of the Vv.16s vector using the least significant 5 bits of the i-th element.

For each iteration of the for loop 412, the value of the Segmen_Id_In variable is compared to the variable “x” as shown. If the value of the Segmen_Id_In is less than the variable “x”, then the value of the variable “x” is compared to the variable “a” as shown. Otherwise, a variable “Final_Id” is assigned the value of the Segmen_Id_In.

As shown, if the value of the variable “x” is greater than the value of the variable “a”, a bitwise AND operation may be performed on the Segmen_Id_In variable and the variable “Final_Id” may be assigned the resultant of the bitwise AND operation.

If the value of the variable “x” is less than the value of the variable “a”, a different bitwise AND operation may be performed on the Segmen_Id_In variable as shown and the variable “Final_Id” may be assigned the resultant of the bitwise AND operation.

As shown, in some aspects, the function 402 may include an else if statement 414 that is executed if the value of the “Segmen_Id_In” variable is less than the sum of the variable “x” and the variable “y” as shown. Within the else if statement 414, the variable “y” may be compared to variable “b”. If the value of variable “y” is greater than the value of variable “b”, the variable “final_Id” may be assigned a value based on the sum of the variable “a” and a portion (e.g., the 5 least significant bits) of the “Segmen_Id_In” variable.

Alternatively, if the value of the variable “y” is less than the value of the variable “b”, the variable “final_Id” may be assigned a value based on the sum of the variable “a” and a portion (e.g., the least 5 significant bits) of the “Segmen_Id_Out” variable as shown.

If the value of the variable “y” is equal to the value of the variable “b”, the variable “final_Id” may be assigned a value corresponding to the difference between the sum of the variable “a” and the “Segmen_Id_In” variable minus the variable “x” as shown.

If the condition (e.g., Segmen_Id_In<(x+y) for the else if loop 414 is not satisfied, the function 402 may execute else statement 416 in which the variable “z” is compared to the variable “c” as shown. For instance, if the value of the variable “z” is greater than the value of the variable “c”, then the variable “final_Id” is assigned the resultant of variable “a” plus variable “b” plus a portion of the “Segmen_Id_In” variable as shown.

Alternatively, if the value of the variable “z” is less than the value of the variable “c”, then the variable “final_Id” is assigned the result of variable “a” plus variable “b” plus a portion of the “Segmen_Id_Out” variable as shown.

As shown, if the value of the variable “z” is neither greater than the variable “b” nor less than the variable “b”, then the function 402 may execute else statement 418. Within else statement 418, the “final_Id” variable may be assigned the result of the variable “a” plus the variable “b” plus the “Segmen_Id_In” variable minus the sum of the variable “x” and the variable “y” as shown.

At 420, the output, Vdd, of the function 402 is generated based, at least in part, on the value of the “final_Id” variable” as shown.

It should be appreciated that the algorithm 400 discussed above in FIG. 4 may be executed by a processing system, such as the processing system discussed below in FIG. 6 to compute a non-linear function by approximating same using a plurality of stepwise linear functions that are allocated in a non-uniform manner (e.g., like illustrated in FIG. 3) to minimize error between the non-linear function and the approximation of the non-linear function compared to the error between the non-linear function and the approximation of the non-linear function using conventional approximation techniques in which the linear stepwise polynomial functions are, in contrast to the disclosed techniques, distributed in a uniform manner.

### Example Method for Computing Non-Linear Functions

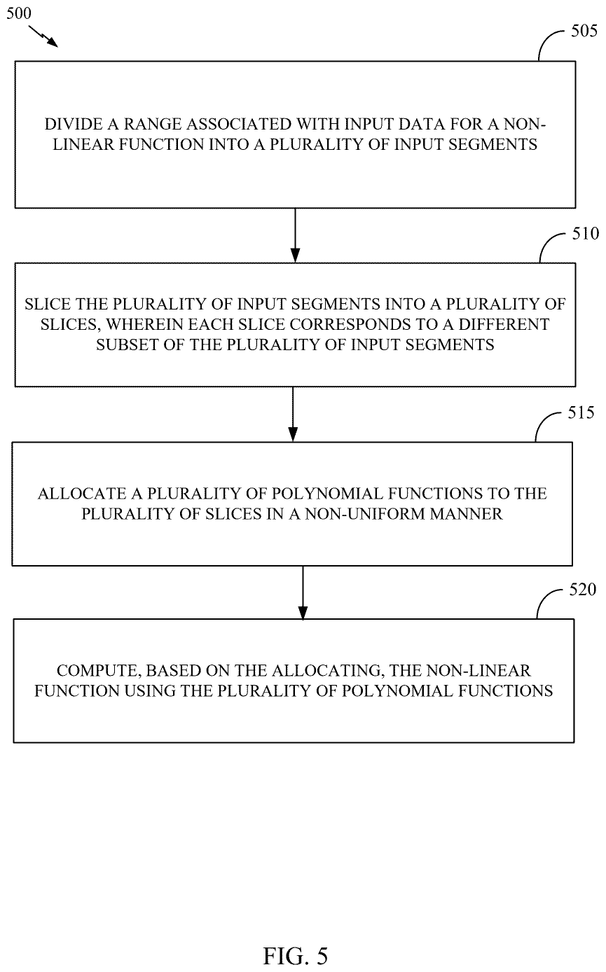

FIG. 5 is a diagram depicting an example method 500 for computing non-linear functions, according to various aspects of the present disclosure. For example, method 500 may be performed by a processing system such as processing system 600 of FIG. 6, described below.

Method 500 begins at block 505 with dividing a range associated with input data for a non-linear function into a plurality of input segments. For instance, input data for the non-linear function may include a minimum value and a maximum value and the range of the input data may be the difference between the maximum value and the minimum value. Furthermore, dividing the range into the plurality of segments may include dividing the range by a particular number to generate the plurality of input segments. For example, in certain aspects, the particular number may be 32 and, in such aspects, the range for the input data of the non-linear function may be divided by 32 to generate 32 different input segments.

Method 500 continues at 510 with slicing the plurality of input segments into a plurality of slices, with each slice corresponding to a different subset of the plurality of input segments. Furthermore, in some aspects, the total number of input segments included in a slice may differ. For example, a first slice of the plurality of slices may include fewer input segments than a second slice of the plurality of slices.

Method 500 continues at 515 with allocating a plurality of linear polynomial functions to the plurality of slices in a non-uniform manner. For instance, a first slice of the plurality of slices may be allocated fewer linear polynomial functions than a second slice of the plurality of slices. More specifically, the first slice of the plurality of slices may correspond to a portion of the non-linear function that is substantially flat, whereas the second slice of the plurality of slices may correspond to a portion of the non-linear function that is substantially curved. Thus, by allocating fewer linear polynomial functions to the first slice and more linear polynomial functions to the second slice, an error associated with approximating the non-linear function may be reduced compared to conventional approaches in which the linear polynomial functions are allocated in a uniform manner.

Method 500 continues at 520 with computing, based on the allocating at 515, the non-linear function using the plurality of linear polynomial functions. For example, computing the non-linear function may include evaluating each of the plurality of linear polynomial functions using respective input values included in the input data.

### Example Processing System for Computing Non-Linear Functions

In some aspects, the techniques and methods described with reference to FIGS. 3-5 may be implemented on one or more devices or systems. FIG. 6 depicts an example processing system 600 configured to perform various aspects of the present disclosure, including, for example, the techniques and methods described with respect to FIGS. 3-5. Although depicted as a single system for conceptual clarity, in some aspects, as discussed above, the operations described below with respect to the processing system 600 may be distributed across any number of devices or systems.

The processing system 600 includes a central processing unit (CPU) 602. Instructions executed at the CPU 602 may be loaded, for example, from a memory 624 associated with the CPU 602.

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

The memory 624 may, in some aspects, include the algorithm 400 discussed above with reference to FIG. 4.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

Implementation examples are described in the following numbered clauses:

Aspect 1: A method for computing non-linear functions, comprising: dividing a range associated with input data for a non-linear function into a plurality of input segments; slicing the plurality of input segments into a plurality of slices, wherein each slice corresponds to a different subset of the plurality of input segments; allocating a plurality of polynomial functions to the plurality of slices in a non-uniform manner; and computing, based on the allocating, the non-linear function using the plurality of polynomial functions.

Aspect 2: The method of Aspect 1, wherein: a first slice of the plurality of slices corresponds to a first subset of input values included in the input data; and a second slice of the plurality of slices corresponds to a second subset of input values included in the input data, wherein the first subset of input values and the second subset of input values are mutually exclusive.

Aspect 3: The method of Aspect 2, wherein a total number of polynomial functions allocated for the second slice is different than a total number of polynomial functions allocated for the first slice.

Aspect 4: The method of Aspect 1, wherein each of the plurality of polynomial functions comprises a linear step piecewise function.

Aspect 5: The method of Aspect 4, wherein the computing comprises: determining one or more input parameters for each respective linear step piecewise function allocated for a respective slice of the plurality of slices; and evaluating each respective linear polynomial function allocated for the respective slice based on the one or more input parameters and a corresponding input value included in the input data.

Aspect 6: The method of Aspect 5, wherein, for each respective linear step piecewise function, the determining comprises obtaining the one or more input parameters based on the corresponding input value.

Aspect 7: The method of Aspect 6, wherein the obtaining comprises using a portion of the corresponding input value as a lookup table to obtain the one or more input parameters.

Aspect 8: The method of Aspect 1, wherein the non-linear function is associated with one or more layers of a machine learning model.

Aspect 9: The method of Aspect 8, wherein the one or more layers comprise an activation layer of the machine learning model.

Aspect 10: A processing system for computing non-learning functions, comprising: at least one memory having executable instructions stored thereon; and one or more processors configured to execute the executable instructions to cause the processing system to perform operations comprising: dividing a range associated with input data for a non-linear function into a plurality of input segments; slicing the plurality of input segments into a plurality of slices, wherein each slice corresponds to a different subset of the plurality of input segments; allocating a plurality of polynomial functions to the plurality of slices in a non-uniform manner; and computing, based on the allocating, the non-linear function using the plurality of polynomial functions.

Aspect 11: The processing system of Aspect 10, wherein: a first slice of the plurality of slices corresponds to a first subset of input values included in the input data; and a second slice of the plurality of slices corresponds to a second subset of input values included in the input data, wherein the first subset of input values and the second subset of input values are mutually exclusive.

Aspect 12: The processing system of Aspect 11, wherein a total number of polynomial functions allocated for the second slice is different than a total number of polynomial functions allocated for the first slice.

Aspect 13: The processing system of Aspect 10, wherein each of the plurality of polynomial functions comprises a linear step piecewise function.

Aspect 14: The processing system of Aspect 13, wherein the computing comprises: determining one or more input parameters for each respective linear step piecewise function allocated for a respective slice of the plurality of slices; and evaluating each respective linear polynomial function allocated for the respective slice based on the one or more input parameters and a corresponding input value included in the input data.

Aspect 15: The processing system of Aspect 14, wherein, for each respective linear step piecewise function, the determining comprises obtaining the one or more input parameters based on the corresponding input value.

Aspect 16: The processing system of Aspect 15, wherein the obtaining comprises using a portion of the corresponding input value as a lookup table to obtain the one or more input parameters.

Aspect 17: The processing system of Aspect 10, wherein the non-linear function is associated with one or more layers of a machine learning model.

Aspect 18: The processing system of Aspect 17, wherein the one or more layers comprise an activation layer of the machine learning model.

Aspect 19: The processing system of Aspect 18, wherein the non-linear function comprises a softmax function.

Aspect 20: A non-transitory computer-readable medium comprising instructions to be executed in a processor, wherein the instructions when executed in the processor cause the processor to perform operations comprising: dividing a range associated with input data for a non-linear function into a plurality of input segments; slicing the plurality of input segments into a plurality of slices, wherein each slice corresponds to a different subset of the plurality of input segments; allocating a plurality of polynomial functions to the plurality of slices in a non-uniform manner; and computing, based on the allocating, the non-linear function using the plurality of polynomial functions.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for computing non-linear functions, comprising:
dividing a range associated with input data for a non-linear function into a plurality of input segments;
slicing the plurality of input segments into a plurality of slices, wherein each slice corresponds to a different subset of the plurality of input segments;
allocating a plurality of polynomial functions to the plurality of slices in a non-uniform manner; and
computing, based on the allocating, the non-linear function using the plurality of polynomial functions.

2. The method of claim 1, wherein:
a first slice of the plurality of slices corresponds to a first subset of input values included in the input data; and
a second slice of the plurality of slices corresponds to a second subset of input values included in the input data, wherein the first subset of input values and the second subset of input values are mutually exclusive.

3. The method of claim 2, wherein a total number of polynomial functions allocated for the second slice is different than a total number of polynomial functions allocated for the first slice.

4. The method of claim 1, wherein each of the plurality of polynomial functions comprises a linear step piecewise function.

5. The method of claim 4, wherein the computing comprises:
determining one or more input parameters for each respective linear step piecewise function allocated for a respective slice of the plurality of slices; and
evaluating each respective linear polynomial function allocated for the respective slice based on the one or more input parameters and a corresponding input value included in the input data.

6. The method of claim 5, wherein, for each respective linear step piecewise function, the determining comprises obtaining the one or more input parameters based on the corresponding input value.

7. The method of claim 6, wherein the obtaining comprises using a portion of the corresponding input value as a lookup table to obtain the one or more input parameters.

8. The method of claim 1, wherein the non-linear function is associated with one or more layers of a machine learning model.

9. The method of claim 8, wherein the one or more layers comprise an activation layer of the machine learning model.

10. A processing system for computing non-learning functions, comprising:
at least one memory having executable instructions stored thereon; and
one or more processors configured to execute the executable instructions to cause the processing system to perform operations comprising:
dividing a range associated with input data for a non-linear function into a plurality of input segments;
slicing the plurality of input segments into a plurality of slices, wherein each slice corresponds to a different subset of the plurality of input segments;
allocating a plurality of polynomial functions to the plurality of slices in a non-uniform manner; and
computing, based on the allocating, the non-linear function using the plurality of polynomial functions.

11. The processing system of claim 10, wherein:
a first slice of the plurality of slices corresponds to a first subset of input values included in the input data; and
a second slice of the plurality of slices corresponds to a second subset of input values included in the input data, wherein the first subset of input values and the second subset of input values are mutually exclusive.

12. The processing system of claim 11, wherein a total number of polynomial functions allocated for the second slice is different than a total number of polynomial functions allocated for the first slice.

13. The processing system of claim 10, wherein each of the plurality of polynomial functions comprises a linear step piecewise function.

14. The processing system of claim 13, wherein the computing comprises:
determining one or more input parameters for each respective linear step piecewise function allocated for a respective slice of the plurality of slices; and
evaluating each respective linear polynomial function allocated for the respective slice based on the one or more input parameters and a corresponding input value included in the input data.

15. The processing system of claim 14, wherein, for each respective linear step piecewise function, the determining comprises obtaining the one or more input parameters based on the corresponding input value.

16. The processing system of claim 15, wherein the obtaining comprises using a portion of the corresponding input value as a lookup table to obtain the one or more input parameters.

17. The processing system of claim 10, wherein the non-linear function is associated with one or more layers of a machine learning model.

18. The processing system of claim 17, wherein the one or more layers comprise an activation layer of the machine learning model.

19. The processing system of claim 18, wherein the non-linear function comprises a softmax function.

20. A non-transitory computer-readable medium comprising instructions to be executed in a processor, wherein the instructions when executed in the processor cause the processor to perform operations comprising:
dividing a range associated with input data for a non-linear function into a plurality of input segments;
slicing the plurality of input segments into a plurality of slices, wherein each slice corresponds to a different subset of the plurality of input segments;
allocating a plurality of polynomial functions to the plurality of slices in a non-uniform manner; and
computing, based on the allocating, the non-linear function using the plurality of polynomial functions.
